(19) United States
(12) Patent Application Publication
(10) Pub. No.: US 2008/0284740 A1
(43) Pub. Date: Nov. 20, 2008

(54) Wireless multi-user touch control device

(76) Inventor: Hsien-Chung Chou, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/819,006

(22) Filed: Jun. 25, 2007

(30) Foreign Application Priority Data
May 18, 2007 (TW) 096208162

(51) Int. Cl. G06F 3/041

(52) U.S. Cl. 345/173

(57) ABSTRACT

A wireless multi-user touch control device including at least one input unit having a touch control input pad and a radio transmission element. A user can touch the touch control input pad to write characters or draft drawings thereon. The input unit serves to convert the characters and drawings into digital signals which are transmitted by the radio transmission element by way of radio frequency. The wireless multi-user touch control device further includes a receiving unit having a receiver, a mainframe and a display. The receiver responsively receives the radio signals transmitted from the input unit and input the radio signals to a processing unit of the mainframe for processing the signals. Thereafter, the display shows the characters or drawings identical to those written on the touch control input pad of the input unit by the user.

### BACKGROUND OF THE INVENTION

1. Field of the Invention

The present invention is related to a wireless multi-user touch control device. By means of radio signals, a receiving unit can at the same time wirelessly receive the signals of the character and drawing signals written on multiple touch control input pads by multiple users. A display can synchronously show the characters and drawings identical to those written on the touch control input pads. Therefore, the wireless multi-user touch control device is applicable to multipartite meeting, interactive class, etc. as a discussion platform.

2. Description of the Prior Art

FIG. 1 shows a current wired single handwriting input board 31. The handwriting input board 31 is connected to a computer mainframe 33 via a connecting wire 32. A user can touch the handwriting input board 31 to write characters or draft drawings on the handwriting input board 31. Through the processing of the computer mainframe 33, the signals are transmitted to a display 34 for showing the characters or drawings. Such handwriting input board 31 can be used in various fields such as personal demonstration.

The handwriting input board 31 is connected to the computer mainframe 33 via the connecting wire 32. Therefore, when used, it is necessary to lay out the wire. Such procedure is quite troublesome. Moreover, due to the limitation of the layout of the connecting wire 32, it is impossible to freely change the location of the handwriting input board 31. Besides, in general, only one single handwriting input board 31 can be connected to one computer mainframe 33 for one user to use. Therefore, it is impossible to use such single handwriting input board 31 in a multi-user meeting such as a multiparty interactive class of a teacher and many students.

### SUMMARY OF THE INVENTION

It is therefore a primary object of the present invention to provide a wireless multi-user touch control device including at least one input unit having a touch control input pad and a radio transmission element. A user can touch the touch control input pad to write characters or draft drawings thereon. The input unit serves to convert the characters and drawings into digital signals which are transmitted by the radio transmission element by way of radio frequency. The wireless multi-user touch control device further includes a receiving unit having a receiver, a mainframe and a display. The receiver responsively receives the radio signals transmitted from the input unit and input the radio signals to a processing unit of the mainframe for processing the signals. Thereafter, the display shows the characters or drawings identical to those written on the touch control input pad of the input unit by the user.

It is a further object of the present invention to provide the above wireless multi-user touch control device which includes multiple input units each having a touch control input pad and a radio transmission element. The same receiving unit can at the same time receive the character and drawing signals input by different users and transmitted from the radio transmission elements. The display can synchronously show the characters and drawings identical to those written on the touch control input pads of the input units by different users. Therefore, the wireless multi-user touch control device serves as a multipartite interactive discussion platform.

The present invention can be best understood through the following description and accompanying drawings wherein:

### BRIEF DESCRIPTION OF THE DRAWINGS

FIG. 1 is a schematic diagram showing the application of a conventional single handwriting input board;

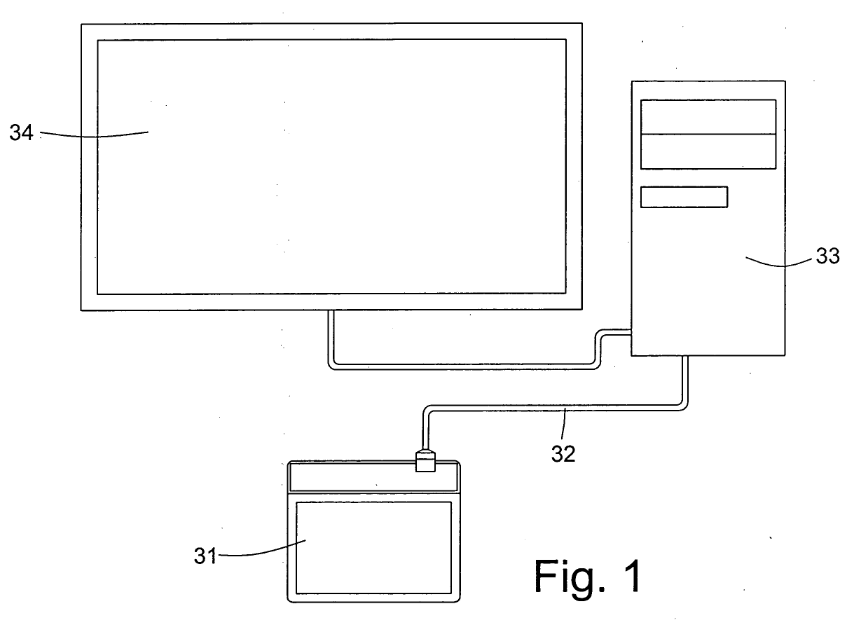

FIG. 2 is a block diagram of the wireless multi-user touch control device of the present invention; and

FIG. 3 is a schematic diagram showing the application of the wireless multi-user touch control device of the present invention.

### DETAILED DESCRIPTION OF THE PREFERRED EMBODIMENTS

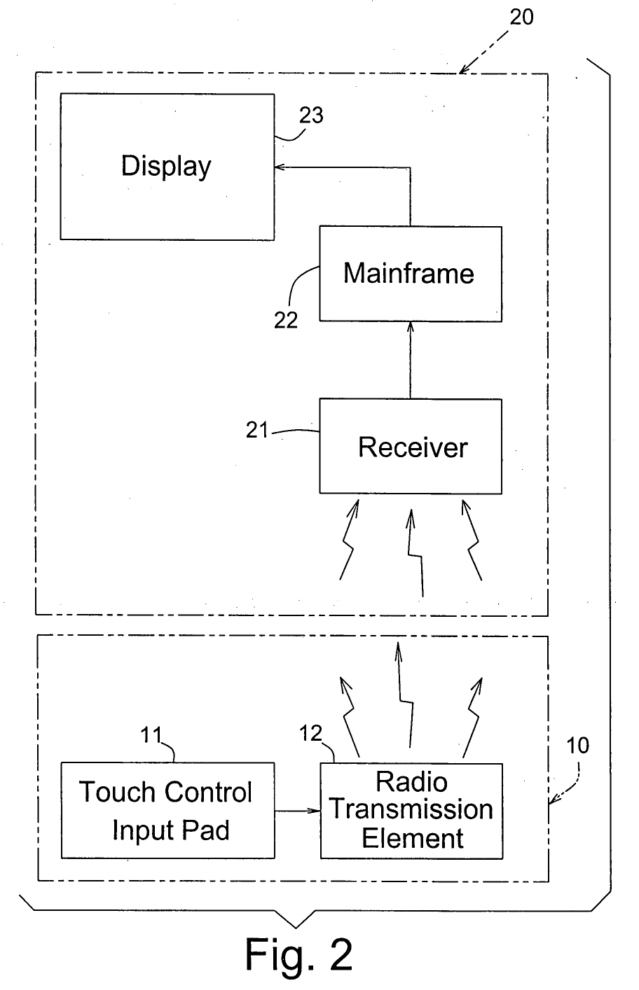

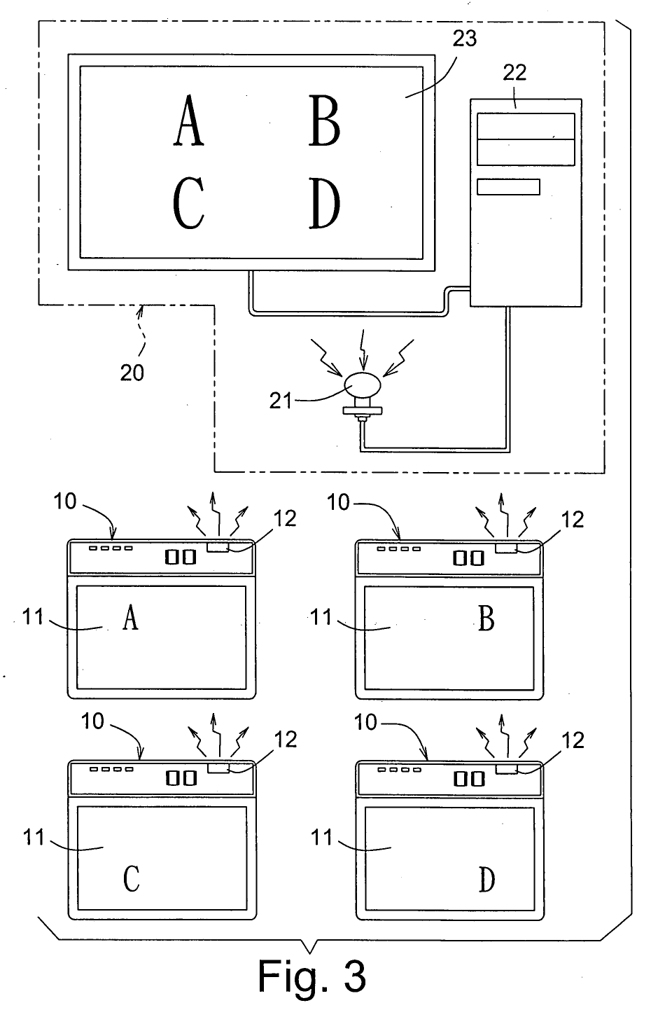

Please refer to FIGS. 2 and 3. The wireless multi-user touch control device of the present invention includes at least one input unit 10 having a touch control input pad 11 and a radio transmission element 12. A user can touch the touch control input pad 11 to write characters or draft drawings thereon. The input unit 10 serves to convert the characters and drawings into digital signals which are transmitted by the radio transmission element 12 by way of radio frequency. The present invention further includes a receiving unit 20 having a receiver 21, a mainframe 22 and a display 23. The receiver 21 responsively receives the radio signals transmitted from the input unit 10 and inputs the radio signals to the processing unit of the mainframe 22. Thereafter, the display 23 shows the characters and drawings identical to those written on the touch control input pad 11 by the user.

Referring to FIG. 3, the wireless multi-user touch control device of the present invention includes multiple input units 10 each having a touch control input pad 11 and a corresponding wireless transmission element 12. As shown in FIG. 3, four alphabets “A”, “B”, “C” and “D” are respectively written on four touch control input pads 11. The radio transmission elements 12 respectively transmit radio signals which are received by the receiver 21 of the same receiving unit 20. The same display 23 synchronously shows the characters or drawings written on the touch control input pads 11 of the input units 10. As shown in FIG. 3, the display 23 at the same time shows the four alphabets “A”, “B”, “C” and “D” written on the four touch control input pads 11. Accordingly, multiple users can use the present invention at the same time as a platform for interactive discussion.

In the wireless multi-user touch control device of the present invention, the mainframe 22 of the receiving unit 20 can be a personal desktop computer, a notebook or the like. The display 23 can be an electronic whiteboard, a projector, a liquid crystal display or the like. This is not limited.

The wireless multi-user touch control device of the present invention is characterized in that a user can touch and write characters or draft drawings on the touch control input pad 11 of the input unit 10. Then the input unit 10 converts the characters or drawings into digital signals which are transmitted by the radio transmission element 12 by way of radio frequency. The receiver 21 of the receiving unit 20 receives the radio signals transmitted from the radio transmission element 12 of the touch control input pad 11 or receives the radio signals transmitted from the multiple radio transmission elements 12 of the touch control input pads 11. Then the receiver 21 inputs the radio signals to the processor of the mainframe 22. After processed, the signals are sent to the display 23 to show the characters and drawings written on the touch control input pads 11 by the user or the users. According to the above arrangement, the present invention has the following advantages:

1. The input unit 10 is wirelessly connected to the receiving unit 20. Therefore, it is unnecessary to lay out any wire when installing the multi-user touch control device of the present invention. Therefore, it is convenient to install the device.

2. In a certain space, a user can freely walk and carry the touch control input pad 11 with him/her. Therefore, the mobility of use is enhanced.

3. The receiving unit 20 can at the same time receive the character and drawing signals input by different users and transmitted from the input units 10. The display 23 can synchronously show the characters and drawings written on the touch control input pads 11 of the input units 10. The wireless multi-user touch control device of the present invention is applicable to multipartite meeting, interactive class, etc. as a discussion platform.

The above embodiments are only used to illustrate the present invention, not intended to limit the scope thereof. Many modifications of the above embodiments can be made without departing from the spirit of the present invention.

What is claimed is:

1. A wireless multi-user touch control device comprising:
(a) at least one input unit having a touch control input pad and a radio transmission element, whereby a user can touch the touch control input pad to write characters or draft drawings thereon, the input unit serving to convert the characters and drawings into digital signals which are transmitted by the radio transmission element by way of radio frequency; and
(b) a receiving unit having a receiver, a mainframe and a display, the receiver responsively receiving the radio signals transmitted from the input unit and inputting the radio signals to a processing unit of the mainframe for processing the signals, then the display showing the characters or drawings identical to those written on the touch control input pad of the input unit.

2. The wireless multi-user touch control device as claimed in claim 1, wherein there are multiple input units.

3. The wireless multi-user touch control device as claimed in claim 1, wherein the display is an electronic whiteboard.

4. The wireless multi-user touch control device as claimed in claim 2, wherein the display is an electronic whiteboard.
